(19) United States
(12) Patent Application Publication
(10) Pub. No.: US 2023/0053921 A1
(43) Pub. Date: Feb. 23, 2023

(54) STEERING SYSTEM

(71) Applicant: ZF FRIEDRICHSHAFEN AG, Friedrichshafen (DE)

(72) Inventors: Daniel E. WILLIAMS, Thorntown, IN (US); Shreyas Sharad CHAUDHARI, Lafayette, IN (US); Pranav Rajendra SALUNKE, West Lafayette, IN (US); Ananda Kamakshi Rajah PANDY, West Lafayette, IN (US)

(21) Appl. No.: 17/797,487

(22) PCT Filed: Feb. 8, 2021
(86) PCT No.: PCT/IB2021/051003

§ 371 Date: Aug. 4, 2022

Related U.S. Application Data
(60) Provisional application No. 62/971,379, filed on Feb. 7, 2020.

(51) Int. Cl. B62D 6/00; B62D 5/04; B62D 15/02

(52) U.S. Cl. CPC B62D 6/00; B62D 5/0409; B62D 15/0215

(57) ABSTRACT

A method of steering steerable wheels of a vehicle includes applying a first torque to a steering column of the vehicle with a first motor. It is determined if the first motor is attempting to apply a torque to the steering column greater than a predetermined torque. A torque greater than the predetermined torque is applied to the steering column with at least one of the first motor and/or a torque is applied to the steering column with a second motor.

### RELATED APPLICATION

This application claims priority to U.S. Provisional Application Ser. No. 62/971,379 filed Feb. 7, 2020, the subject matter of which is incorporated herein by reference in its entirety.

### TECHNICAL FIELD

The present invention relates to a steering system for turning steerable wheels of a vehicle, and, more specifically to a steering system for turning steerable wheels in response to rotation of a vehicle steering wheel and/or autonomously.

### BACKGROUND

Vehicle steering systems for commercial vehicles do not support autonomous steering of the vehicle without an operator/driver of the vehicle. The operator of the vehicle determines the effects of any failure related to the steering system and controls the vehicle steering in the event of the failure. Therefore, an operator is necessary for the safe operation of the vehicle. The operator of the vehicle is necessary to detect an increased steering effort if there is a failure or reduction in hydraulic fluid flow to a hydraulic steering gear or any mechanical binding that increases the steering effort required to actuate the steering gear.

### SUMMARY

The present invention provides a method of steering steerable wheels of a vehicle including applying a first torque to a steering column of the vehicle with a first motor. It is determined if the first motor is attempting to apply a torque to the steering column greater than a predetermined torque. A torque greater than the predetermined torque is applied to the steering column with at least one of the first motor and/or a torque is applied to the steering column with a second motor.

In another aspect of the present invention, determining if the first motor is attempting to apply a torque to the steering column greater than a predetermined torque includes comparing at least one of a torque applied by the first motor, a desired torque to be applied by the first motor to the steering column, a torque applied to the steering column, a speed at which the steering column is rotating, a rotational acceleration of the steering column, a current supplied to the first motor, a vehicle speed and an angle of the steering column to at least one desired parameter to determine if the first motor is attempting to apply a torque to the steering column greater than the predetermined torque.

In yet another aspect of the present invention, determining if the first motor is attempting to apply a torque to the steering column greater than a predetermined torque includes comparing at least one of a vehicle speed, an angle of the steering column and a vehicle yaw rate to at least one desired parameter to determine if the first motor is attempting to apply a torque to the steering column greater than the predetermined torque.

In yet another aspect of the present invention, determining if the first motor is attempting to apply a torque to the steering column greater than a predetermined torque includes comparing at least one of a temperature of fluid flowing through a steering gear, a flow rate of fluid flowing to the steering gear and a pressure of fluid flowing to the steering gear to at least one desired parameter to determine if the first motor is attempting to apply a torque to the steering column greater than the predetermined torque.

In yet another aspect of the present invention, determining if the first motor is attempting to apply a torque to the steering column greater than a predetermined torque includes comparing a torque applied by the first motor, a desired torque to be applied by the first motor to the steering column, a torque applied to the steering column, a speed at which the steering column is rotating, a rotational acceleration of the steering column, a current supplied to the first motor, a vehicle speed, an angle of the steering column, a vehicle yaw rate, a temperature of fluid flowing through a steering gear, a flow rate of fluid flowing to the steering gear and a pressure of fluid flowing to the steering gear to desired parameters to determine if the first motor is attempting to apply a torque to the steering column greater than the predetermined torque.

### BRIEF DESCRIPTION OF THE DRAWINGS

The foregoing and other features and advantages of the invention will become apparent to one skilled in the art upon consideration of the following description of the invention and the accompanying drawings in which:

FIG. 1 is a schematic illustration of a vehicle steering system constructed in accordance with the present invention to turn steerable vehicle wheels;

FIG. 2 is a schematic illustration of a control system for the steering system of FIG. 1; and

FIG. 3 is shows a method of controlling the steering system of FIGS. 1 and 2.

### DESCRIPTION

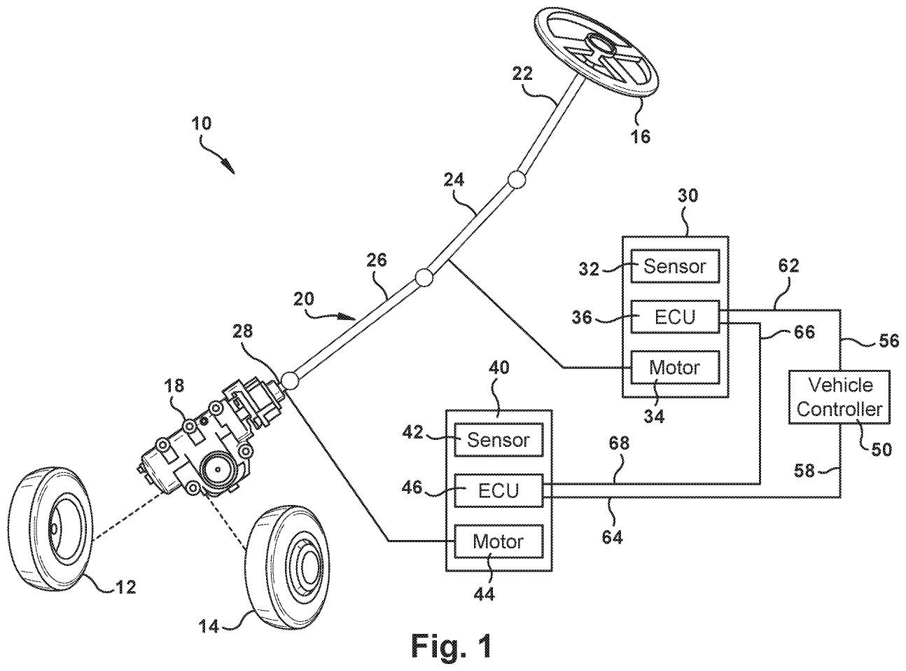

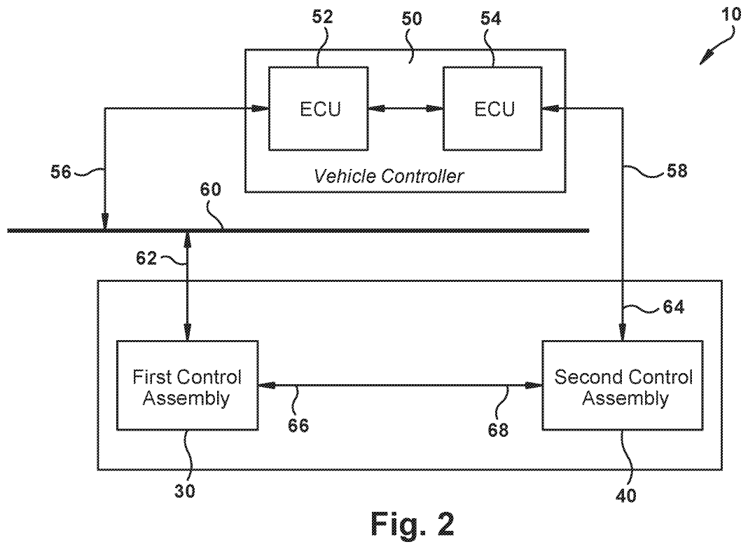

A steering system 10 to turn steerable vehicle wheels 12, 14 is schematically illustrated in FIGS. 1 and 2. The steering system 10 may be actuated by an operator/driver of the vehicle and/or actuated autonomously. The steering system 10 includes a handwheel or steering wheel 16 which may be rotated by an operator of the vehicle. The handwheel 16 is connected with a steering gear 18 by a steering column 20. The steering gear 18 may be any desired steering gear, such as a hydraulically powered integral steering gear or a rack and pinion type.

The steering column 20 may include a handwheel portion 22 which is connected with the handwheel 16. A first intermediate portion 24 of the steering column may be connected to the handwheel portion 22. A second intermediate portion 26 of the steering column 20 may be connected to the first intermediate portion 24 and an input shaft 28 of the steering gear 18. Universal joints may interconnect the handwheel portion 22, the first intermediate portion 24, the second intermediate portion 26 and the steering gear input shaft 28. Although the steering column 20 is shown as having a handwheel portion 22 and first and second intermediate portions 24, 26, it is contemplated that the steering column may have any desired construction.

Upon rotation of the handwheel 16, rotational force is transmitted through the steering column 20 to the steering gear 18. The rotational force effects operation of the steering gear 18. Upon operation of the steering gear 18, the steering gear effects turning movement of the steerable vehicle wheels 12, 14 in a known manner through a steering linkage.

The steering system 10 includes a first control assembly 30 which is operably connected with the steering column 20 at a first location that may be adjacent to the handwheel 16. The first control assembly 30 may be connected to the first intermediate portion 24 of the steering column 20. Although the first control assembly 30 is shown as being connected to the first intermediate portion 24, it is contemplated that the first control assembly may be connected to the steering column 20 at any desired location.

The first control assembly 30 includes at least a first sensor 32, a first reversible electric motor 34 and a first electronic control unit (ECU) 36. The first sensor 32 may sense torque applied to the steering column 20 and/or the angular position of the steering column. The first control assembly 30 may be integrated into a single unit through which the first intermediate portion 24 of the steering column 20 passes.

The first torque/position sensor 32 of the first assembly 30 is operable to sense applied torque and angular rotation of the steering wheel 16. The torque/position sensor 32 also generates signals indicative of the applied torque and angular rotation of the steering wheel 16. The torque/position sensor 32 may be any known sensor or group of sensors for sensing applied torque and angular rotation of the steering wheel 16 and for generating signals indicative of the sensed parameters.

The first electric motor 34 is operably connected to the first intermediate portion 24 of the steering column 20, A gear assembly may connect an output of the first electric motor 34 to the steering column 20 in a known manner. The first electric motor 34 applies a torque to the steering column 20 when actuated.

The first electronic control unit 36 is operatively coupled to the first torque/position sensor 32 and to the first electric motor 34. The first electronic control unit 36 may receive signals indicative of the applied torque and angular rotation of the steering wheel 16 from the torque/position sensor 32. The first ECU 36 may also receive signals indicative of vehicle speed, lateral acceleration, and/or other operating conditions associated with the vehicle. In response to the signals from the torque/position sensor 32, the first electronic control unit 36 may actuate the first electric motor 34 to apply a torque to the steering column 20. The first motor 34 may be operated to assist in rotating the first intermediate portion 24 and the handwheel 16. The first motor 34 may also be operated to resist rotation of the intermediate portion 24 and the handwheel 16 to provide “feel” to the operator rotating the handwheel. The first ECU 36 may effect operation of the first motor 34 to either assist or resist rotation of the steering column 20 as a function of vehicle operating conditions when the vehicle is being steered by an operator of the vehicle. Therefore, the first control assembly 30 may apply a desired rotational force to the first intermediate portion 24 of the steering column 20 to provide a desired output torque through the steering column.

A second control assembly 40 may be operably connected with the steering column 20 at a location adjacent to the steering gear 18, The second control assembly 40 may be connected to the input shaft 28 of the steering gear 18. Although the second control assembly 40 is shown as being connected to the input shaft 28, it is contemplated that the second control assembly may be connected to the steering column 20 at any desired location.

The second control assembly 40 may be substantially similar to the first control assembly 30 and includes at least a second sensor 42, a second reversible electric motor 44 and a second electronic control unit 46. The second sensor 42 may sense torque applied to the steering column 20 and/or the angular position of the steering column. The second control assembly 40 may be integrated into a single unit through which the input shaft 28 of the steering gear 18 passes.

The second torque/position sensor 42 of the second control assembly 40 is operable to sense applied torque and angular rotation of the input shaft 28. The second torque/position sensor 42 also generates signals indicative of the applied torque and angular rotation of the input shaft 28. The torque/position sensor 42 may be any known sensor or group of sensors for sensing applied torque and angular rotation of the input shaft 28 and for generating signals indicative of the sensed parameters.

The second electric motor 44 is operably connected to the input shaft 28 of the steering gear 18. A gear assembly may connect an output of the second electric motor 44 to the steering column in a known manner. The second electric motor 44 applies a torque to the steering column 20 when actuated.

The second electronic control unit 46 is operatively coupled to the second torque/position sensor 42 and to the second electric motor 44. The second electronic control unit 46 may receive signals indicative of the applied torque and angular rotation of the input shaft 28 from the second torque/position sensor 42. The second ECU 46 may also receive signals indicative of vehicle speed, lateral acceleration, and/or other operating conditions associated with the vehicle. In response to the signals from the second torque/position sensor 42, the second electronic control unit 46 may actuate the second electric motor 44 to apply a torque to the steering column 20 and the steering gear 18. The second motor 44 may be operated to assist in rotating the input shaft 28. The second motor 44 may also be operated to resist rotation of the input shaft 28. The second ECU 46 may effect operation of the second motor 44 to either assist or resist steering column rotation as a function of vehicle operating conditions when the vehicle is being steered by an operator of the vehicle. Therefore, the second control assembly 40 may apply a desired rotational force to the input shaft 28 of the steering gear 18 and/or to the second intermediate portion 26 of the steering column 20 to provide a desired output torque through the steering column.

A main vehicle controller 50 (FIG. 2) may communicate with the first and second control assemblies 30, 40 over communication channels, such as a Controller Area Network (CAN) or any other desired communication network. The vehicle controller 50 may have first and second ECUs 52, 54 that communicate with each other. The first and second ECUs 52, 54 may communicate with the first and second control assemblies 30, 40 via first and second communication channels 56, 58 of the vehicle controller and a vehicle communication bus 60. The first control assembly 30 may communicate with the vehicle communication bus 60 over a first communication channel 62 of the first control assembly. The second control assembly 40 may communicate directly with the vehicle controller 50 over a first communication channel 64 of the second control assembly. The first and second control assemblies 30, 40 may communicate directly with each other over second communication channels 66, 68 of the first and second control assemblies. The second communication channels 66, 68 may only communicate with each other. Therefore, the first and second control assemblies 30, 40 communicate with each other over dedicated communication channels of the first and second control assemblies.

The vehicle controller 50 may send signals to the ECUs 36, 46 of the first and second control assemblies 30, 40 to operate the vehicle autonomously. The vehicle controller 50 actuates at least one of the first and second control assemblies 30, 40 to turn the steering column 20 and the steerable vehicle wheels 12, 14 to steer the vehicle autonomously. It is contemplated that the vehicle controller 50 may actuate both of the first and second control assemblies simultaneously to turn the steerable vehicle wheels 12, 14.

The vehicle controller 50 may send the same position commands to the first and second control assemblies 30, 40 to create a redundant system. The first and second control assemblies 30, 40 may communicate with each other to determine which control assembly will steer the vehicle autonomously. The other control assembly will act as a backup or redundant control assembly and steer the vehicle autonomously if the one control assembly fails to steer the vehicle. For example, the first and second ECUs 36, 46 of the first and second control assemblies 30, 40 may communicate with each other and determine that the second control assembly 40 will steer the vehicle autonomously, The second ECU 46 of the second control assembly 40 receives the position signal or command from the vehicle controller 50 to autonomously steer the vehicle. In response to the position signal from the vehicle controller 50, the second ECU 46 actuates the second electric motor 44 to apply a torque to the steering column 20 and actuate the steering gear 18 to turn the steerable vehicle wheels 12, 14. The first ECU 36 of the first control assembly 30 communicates with the second ECU 46 of the second control assembly to determine if the first motor 34 needs to apply a torque to the steering column 20. The first ECU 36 of the first control assembly 30 does not actuate the first motor 34 if it is determined that the first motor does not need to apply a torque to the steering column 20. If it is determined that the first motor needs to apply a torque to the steering column 20, the first ECU actuates the first motor 34 to apply a torque to the steering column 20 in response to the position signal or command from the vehicle controller 50. Therefore, the first control assembly 30 acts as a backup for the second control assembly 40. The first control assembly 30 may autonomously turn the steering column 20 and the steerable vehicle wheels 12, 14 in response to the signals received from the vehicle controller 50 if the second control assembly 40 malfunctions.

If communication from the main controller 50 to the second control assembly 40 fails, the signals from the main controller may be transmitted through the first ECU 36 of the first control assembly 30 to the second control assembly. Thus, the second control assembly 40 may continue to apply torque to the steering column 20 and actuate the steering gear 18 to turn the steerable vehicle wheels 12, 14.

It is also possible that the first and second control assemblies 30, 40 communicate with each other and determine that the first control assembly 30 will steer the vehicle autonomously. The first ECU 36 of the first control assembly 30 receives a position signal or command from the vehicle controller 50 to autonomously steer the vehicle. In response to the position signal from the vehicle controller 50, the first ECU 36 actuates the first electric motor 34 to apply a torque to the steering column 20 to actuate the steering gear 18 and turn the steerable vehicle wheels 12, 14. The second ECU 46 of the second control assembly 40 communicates with the first ECU 36 of the first control assembly to determine if the second motor 44 needs to apply a torque to the steering column 20. The second ECU 46 of the second control assembly 40 does not actuate the second motor 44 if it is determined that the second motor does not need to apply a torque to the steering column 20. If it is determined that the second motor needs to apply a torque to the steering column 20, the second ECU actuates the second motor 44 to apply a torque to the steering column 20. Therefore, the second control assembly 40 acts as a backup for the first control assembly 30. The second control assembly 40 may autonomously turn the steering column 20 and the steerable vehicle wheels 12, 14 in response to the signals received from the vehicle controller 50 if the first control assembly 30 malfunctions.

If communication from the main controller 50 to the first control assembly 30 fails, the signals from the main controller may be transmitted through the second ECU 46 of the second control assembly 40 to the first control assembly. Thus, the first control assembly 30 may continue to apply torque to the steering column 20 and actuate the steering gear 18 to turn the steerable vehicle wheels 12, 14.

Each of the first and second control assemblies 30, 40 will know if it needs to act as an individual unit or in combination with the other control assembly. If one of the control assemblies 30, 40 is the only control assembly operating to steer the vehicle autonomously, then the one control assembly only accepts input commands that are related to operating the control assembly to steer the vehicle without assistance from the other control assembly. The other one of the control assemblies only accepts commands that are related to operating the other control assembly as a redundant or backup control assembly. Therefore, the control assemblies 30, 40 act as redundant systems for controlling steering of the vehicle autonomously. Also, at least one of the first and second control assemblies may provide steering assist and/or steering feel when an operator of the vehicle turns the handwheel 16.

The first and second ECUs 36, 46 of the first and second control assemblies 30, 40 may communicate with each other and share information to determine if the one of the first and second control assemblies is working correctly in response to the signals from the vehicle controller. If the one of the first and second control assemblies 30, 40 is not operating correctly, the other of the first and second control assemblies may turn the steering column 20 and/or actuate the steering gear 18 to turn the steerable vehicle wheels 12, 14 to operate the vehicle autonomously. It is also contemplated that the first and second control assemblies 30, 40 may work together to turn the steerable wheels 12, 14 if both are working properly.

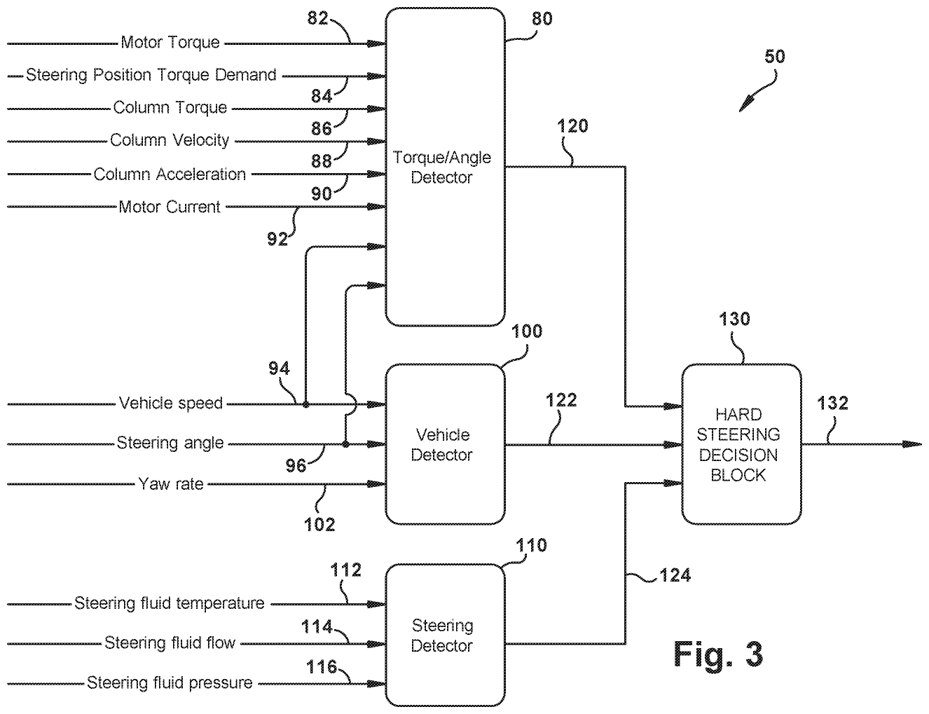

The vehicle controller 50 may receive signals indicative of operating conditions associated with the vehicle. The vehicle controller 50 analyzes the signals and determines if at least one of the first and second motors 34, 44 is attempting to apply a torque to the steering column 20 that is greater than a predetermined torque which indicates a hard steering scenario. The predetermined torque may be a maximum torque that the first and second motors 34, 44 are to apply to the steering column 20 and/or steering gear 18 for safety reasons. If the vehicle controller 50 determines that a hard steering scenario exists, the vehicle controller may generate a control signal for controlling at least one of the first and second control assemblies 30, 40 to alleviate the hard steering scenario. The vehicle controller 50 may increase the torque applied by the one of the first and second motors 34, 44 to a torque greater than the predetermined torque to alleviate the hard steering scenario. FIG. 3 illustrates at least one of the control processes of the vehicle controller 50.

As shown schematically in FIG. 3, a portion of the vehicle controller 50, referred to as a torque/angle detector 80 may determine if at least one of the first and second motors 34, 44 of the first and second control assemblies 30, 40 is attempting to apply a torque to the steering column 20 greater than the predetermined torque. The torque/angle detector 80 may receive motor torque signals 82 indicative of the torque applied by each of the motors 34, 44 of the first and second control assemblies 30, 40. The torque/angle detector 80 may receive steering position torque demand signals 84 indicative of a desired torque that should be applied by the motors 34, 44 to the steering column 20. The torque/angle detector 80 may receive column torque signals 86 indicative of the torque applied to the steering column. The column torque signals 86 may be provided by the torque/position sensors 32, 42 of the control assemblies 30, 40. The torque/angle detector 80 may receive a column velocity signal 88 indicative of the speed at which the steering column 20 is rotating. The torque/angle detector 80 may receive a column acceleration signal 90 indicative of the rotational acceleration of the steering column 20. The torque/angle detector 80 may receive motor current signals 92 indicative of the electric current supplied to the motors 34, 44. The torque/angle detector may receive a vehicle speed signal 94 indicative of the vehicle speed. The torque/angle detector 80 may receive a steering angle signal 96 indicative of the angle of the steering column 20. The torque/angle detector may compare the signals 82-96 to desired parameters for autonomously steering the vehicle to determine if one of the first and second control assemblies 30, 40 is attempting to apply a torque greater than the predetermined torque. If one of the first and second motors 34, 44 is trying to apply a torque above the predetermined torque, it indicates a hard steering situation.

Another portion of the vehicle controller 50, referred to as a vehicle detector 100 may also determine if at least one of the first and second motors 34, 44 of the first and second control assemblies 30, 40 is attempting to apply a torque to the steering column 20 greater than the predetermined torque. The vehicle detector 100 may receive the vehicle speed signal 94 indicative of the vehicle speed and the steering angle signal 96 indicative of the angle of the steering column 20. The vehicle detector 100 may also receive a yaw rate signal 102 indicative of the vehicle yaw rate. The vehicle detector 100 may compare the signals 94, 96 and 102 to desired parameters for autonomously steering the vehicle to determine if one of the first and second control assemblies 30, 40 is attempting to apply a torque greater than the predetermined torque. If one of the first and second motors 34, 44 is trying to apply a torque above the predetermined torque, it indicates a hard steering situation.

Another portion of the vehicle controller 50, referred to as a steering detector 110 may also determine if at least one of the first and second motors 34, 44 of the first and second control assemblies 30, 40 is attempting to apply a torque to the steering column 20 greater than the predetermined torque. The steering detector 110 may receive a steering fluid temperature signal 112 indicative of the temperature of the hydraulic fluid flowing through the steering gear 18. The steering detector 110 may receive a steering fluid flow signal 114 indicative of the flow rate of the hydraulic fluid flowing to the steering gear 18. The steering detector 110 may receive a steering fluid pressure signal 116 indicative of the pressure of the hydraulic fluid flowing to the steering gear 18. The steering detector 100 may compare the signals 112-116 to desired parameters for autonomously steering the vehicle to determine if one of the first and second control assemblies 30, 40 is attempting to apply a torque greater than the predetermined torque. If one of the first and second motors 34, 44 is trying to apply a torque above the predetermined torque, it indicates a hard steering situation.

The torque/angle detector 80 may send a signal 120 to a hard steering decision block 130 which determines if at least one of the first and second motors 34, 44 is in a hard steering scenario. The vehicle detector 100 may send a signal 122 to the hard steering decision block 130. The steering detector 110 may send a signal 124 to the hard steering decision block 130. The hard steering decision block 130 may use at least one of the torque/angle detector signal 120, the vehicle detector signal 122 and the steering detector signal 110 to determine if at least one of the first and second motors 34, 44 of the first and second control assemblies 30, 40 is attempting to apply a torque to the steering column 20 that is greater than the predetermined torque. It is contemplated that the hard steering decision block 130 may use any combination of the torque/angle detector signal 120, the vehicle detector signal 122 and the steering detector signal 110 to determine if at least one of the first and second motors 34, 44 is attempting to apply a torque to the steering column 20 that is greater than the predetermined torque.

The hard steering decision block 130 may send a signal 132 to an external vehicle controller and/or an operator of the vehicle indicating that a hard steering situation has been encountered. The hard steering decision block 130 may also send the signal 132 to at least one of the first and second control assemblies 30, 40 to increase the torque applied by at least one of the first and second motors 34, 44 to a torque greater than the predetermined torque. Therefore, if the steering system 10 detects that one of the first and second motors 34, 44 of the first and second control assemblies 30, 40 is attempting to apply a torque that is greater than the predetermined torque, the steering system 10 may increase the torque applied by the one of the first and second motors to a torque greater than the predetermined torque and/or increase the torque applied by the other of the first and second motors to alleviate the hard steering scenario. If only one of the motors 34, 44 is attempting to apply a torque that is greater than the predetermined torque, the hard steering decision block 130 may send the signal to the other of the first and second control assemblies to have the other motor apply a torque to assist the motor that is attempting to apply a torque greater than the predetermined torque.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

Having described the invention, the following is claimed:

1. A method of steering steerable wheels of a vehicle comprising:
applying a first torque to a steering column of the vehicle with a first motor;
determining if the first motor is attempting to apply a torque to the steering column greater than a predetermined torque; and
applying at least one of a torque greater than the predetermined torque to the steering column with the first motor and a torque to the steering column with a second motor.

2. The method of steering steerable wheels of a vehicle as set forth in claim 1 wherein the step of determining if the first motor is attempting to apply a torque to the steering column greater than a predetermined torque includes comparing at least one of a torque applied by the first motor, a desired torque to be applied by the first motor to the steering column, a torque applied to the steering column, a speed at which the steering column is rotating, a rotational acceleration of the steering column, a current supplied to the first motor, a vehicle speed and an angle of the steering column to at least one desired parameter to determine if the first motor is attempting to apply a torque to the steering column greater than the predetermined torque.

3. The method of steering steerable wheels of a vehicle as set forth in claim 1 wherein the step of determining if the first motor is attempting to apply a torque to the steering column greater than a predetermined torque includes comparing at least one of a vehicle speed, an angle of the steering column and a vehicle yaw rate to at least one desired parameter to determine if the first motor is attempting to apply a torque to the steering column greater than the predetermined torque.

4. The method of steering steerable wheels of a vehicle as set forth in claim 1 wherein the step of determining if the first motor is attempting to apply a torque to the steering column greater than a predetermined torque includes comparing at least one of a temperature of fluid flowing through a steering gear, a flow rate of fluid flowing to the steering gear and a pressure of fluid flowing to the steering gear to at least one desired parameter to determine if the first motor is attempting to apply a torque to the steering column greater than the predetermined torque.

5. The method of steering steerable wheels of a vehicle as set forth in claim 1 wherein the step of determining if the first motor is attempting to apply a torque to the steering column greater than a predetermined torque includes comparing a torque applied by the first motor, a desired torque to be applied by the first motor to the steering column, a torque applied to the steering column, a speed at which the steering column is rotating, a rotational acceleration of the steering column, a current supplied to the first motor, a vehicle speed, an angle of the steering column, a vehicle yaw rate, a temperature of fluid flowing through a steering gear, a flow rate of fluid flowing to the steering gear and a pressure of fluid flowing to the steering gear to desired parameters to determine if the first motor is attempting to apply a torque to the steering column greater than the predetermined torque.

6. The method of steering steerable wheels of a vehicle as set forth in claim 1 wherein a first control assembly includes the first motor and a second control assembly includes the second motor, a vehicle controller communicates with the first and second control assemblies to autonomously steer the vehicle, the second control assembly directly communicating with the first control assembly.

7. The method of steering steerable wheels of a vehicle as set forth in claim 6 further including sending a signal from the vehicle controller to the first and second control assemblies to autonomously steer the vehicle, applying a torque to the steering column with one of the first and second motors to actuate a steering gear and turn the steerable vehicle wheels in response to the signal from the vehicle controller, the first and second control assemblies communicating with each other to determine which control assembly steers the vehicle autonomously.

8. A vehicle steering system as set forth in claim 7 wherein the second control assembly communicates with the first control assembly to determine if the second motor needs to apply a torque to the steering column, the second motor of the second control assembly applying a torque to the steering column.
